(19) United States
(12) Patent Application Publication
(10) Pub. No.: US 2020/0090540 A1
(43) Pub. Date: Mar. 19, 2020

(54) Enhanced Online Learning System

(71) Applicant: Guangwei Yuan, (US)

(72) Inventor: Guangwei Yuan, Fort Collins, CO (US)

(73) Assignee: Guangwei Yuan, Fort Collins, CO (US)

(21) Appl. No.: 16/134,962

(22) Filed: Sep. 19, 2018

(51) Int. Cl. G09B 7/06; G06F 15/18; G06K 9/00

(52) U.S. Cl. CPC G09B 7/06; G06K 9/00288; G06K 9/00342; G06F 15/18

(57) ABSTRACT

An enhanced online learning system is designed to help learners to focus on class and to boost learning experience.

### TECHNICAL DETAIL

Online classrooms gained popularity in recent years, in areas like fundamental education, professional training, and test preparation. But due to lack of an interactive learning environment, learners are easily distracted by different subject, or wonder off from learning materials. It compromises the the efficiency of knowledge delivery, since the student's actual time focused on the learning materials to the total class time is low. To solve this problem, there is a need to implement a real-time system which is able to detect if the learner focused on class. And the system also has ways to send interfere to the learner to bring back attention on class materials,

Here we are utilizing artificial intelligence and machine learning technologies into an online learning system. The new system will also benefit from image processing and pattern recognition, data mining, cloud computing and data storage, big data analysis, and web or mobile application technologies.

In the system, learners have their real-time body languages (seen as distractions) images or video streams recorded by multiple high-resolution cameras. The newly introduced 3D depth cameras, for example, the front-camera of IPhone X, are also considered for this application. Those images or videos are fed into cloud computation platform for further big data analysis. For example, the cloud computation platforms are like Amazon AWS, Google cloud, or Microsoft Azure. In some cases, the images or videos can also be processed locally using high performance processors.

The image of body language (seen as distractions) can be categorized into following activities, expression, emotion (happy, sad, depression, anxious, angry, or excited etc.), head movement, shoulder movement, head up-down angle, head left-right angle, hand movement and writing activity, etc. Face expression might include eyeball movement, eyebrow movement, cheek movement, and mouth/lips movement, etc.

Here we introduce a new parameter, “focus score”, or focus_score. To determine the “focus score”, all body language activities' time have to be quantitated and to be weighted. For simplicity, we assume, for most person, that the learning result often represented as “quiz score”, is linear proportional to “focus score”.

So let's write down the following formula:

focus_score=sum((Tc−wi*qi(activity_i))/Tc)

quiz_score=k*focus_score

focus_score: ratio of focused learning time to total class time

Tc: total class time

qi(activity_i): quantitated time of ith body language activity

activity_i: ith body language activity

wi: weight factor of ith activity

quiz_score: learning result on a section of learning materials

k: an individual's learning capability on a subject

If an activity strongly affects the “quiz score”, the weight is set to high. If the activity weakly affects the “quiz score”, then the weight is set to low or zero. For example, if the learner has a personal habit of looking down and taking notes. More or less, habit does not affect the “quiz scores”, then the weight fact for this activity is set to low or zero.

Let's see how use the collected data to train the system and gain the weights (wi) and k (learning capability). For example, in a 20-minute session of an online class, if a learner looks down onto the table for 5 minutes without taking a note, then qi=5 (minutes) is recorded for the “head look down without note taking” activity. The learning got 80 out of 100 in the session end quiz. In next learning session, the learner pays more attention on class, and only looks down onto the table for 1 minute. In the follow up quiz, the learner gets 90 out of 100. We assume, all other distractions are same, the quiz has similar difficulty level to the learner. Then we know the distraction time of “head look down without note taking” activity to total time was 5/20=25%, and now is 1/20=5%. The improvement is 20% of total time. This leads to (90−80)/100=10% of quiz score improvement. So we say, wi=10%/20%=0.5, is weight factor of the distraction of “head look down without note taking” activity. As shown, we need some amount of collected data to training our system to calculated the weight for all applicable body languages (distractions).

Once we determined the weights (wi) and focus score, the learning capability factor, k, can be calculated using a raw estimation: k=quiz_score/focus_score.

Till now, we have described how to use collected data to train an online learning system model. Next, we will describe how to send interferences back to learner if the system sees that reduction of a distraction activity helps to improve “focus score” and “quiz score”. The system will send interferences to learner, such like higher quiz frequency, more review sessions, or more breaks or warnings. The warnings can be either voice warnings or pop-up text warning messages, which directly ask learner to reduce certain distraction activities.

At last, let's describe other details of this system. The learning materials can be presented on personal computers, internet TVs, classroom boards, or mobile devices. The cameras are placed in the surrounding area to capture high-resolution images or videos streams. The cameras are internet accessible. The cameras are able to upload the video stream or discrete pictures to online computation platform consistently. Image data is eventually to be stored and processed on cloud base computing platform. Further analysis includes data characterization, classification, and correlation. There might be a local computation hub which collects data from the separate cameras also perform basic functions such like raw image data evaluation, and sorting, and filtering, if needed.

The interferences are feedback to the learner through a certain user interface, which might be a separate APP that is displayed on the same screen where the learning materials is displayed. Mobile applications might be utilized, which can be implemented in IOS and Android apps. Individuals (learner, tutors, or teachers) can also access the learning process data, if needed. An alternative access method is webpage based user interface. Beside interferences displayed on the APP, additional functions such as abnormal learning behavior alerts, and learning reports can also be integrated into the applications.

### DRAWING DESCRIPTION

FIG. 1: Illustration of online learning scenario. Multiple cameras capture learner's body languages.

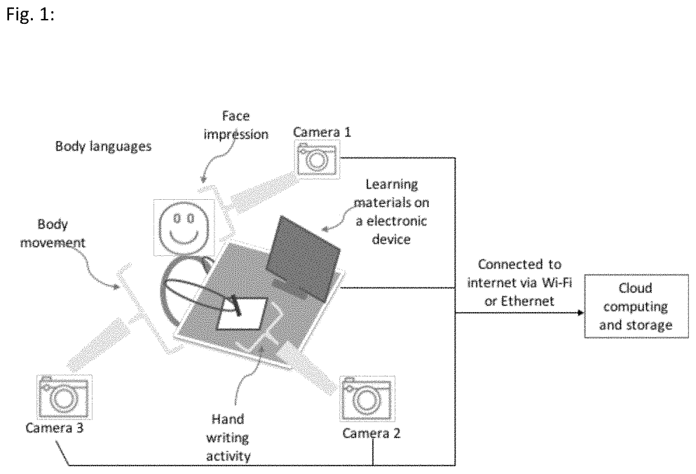

FIG. 2: A complete system diagram.

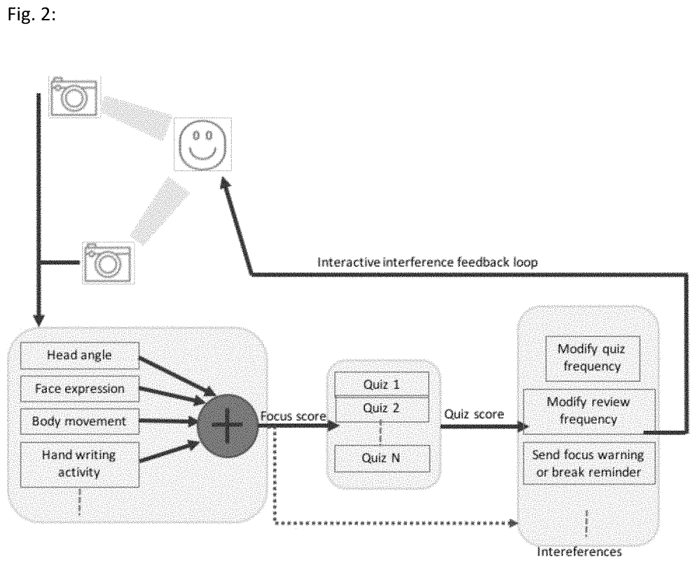

FIG. 3: A system diagram showing focus scores or quiz scores are used to determine weights.

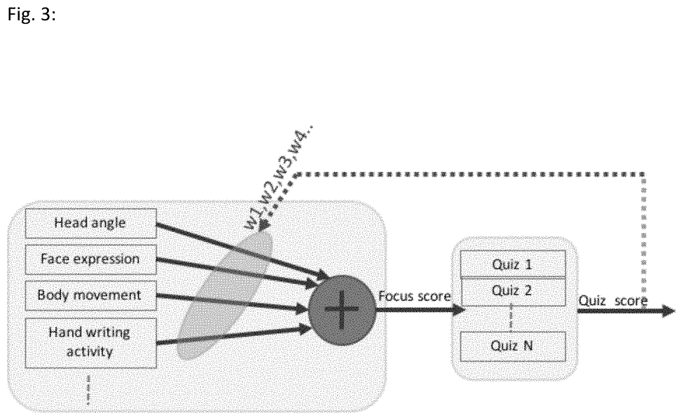

I claim:

1. An enhanced online learning system is designed to improve learners learning results on online classes. High resolution cameras are used to capture learner's body languages (distractions), such like face expression, body movement, and hand writing activity, etc. All the activity items are quantitated. A parameter, “focus score”, is introduced after weighing the times cost on different distractions. If low focus score or low learning result is detected. Interferences, such like more frequent quizzes, more review session, more breaks or more focus warnings, are feedback to the learner, in order to improve learning results.

2. Image pattern recognition technologies are used to categorize a learner's body language activity. The weight of the quantitated activity is set based on calculation of relative gain in learning results. A certain amount of training data is needed to determine the weights.

3. As in claim 1, a certain interference or combination of interferences will be utilized until a learner learning result improves.
